(19) United States
(12) Patent Application Publication
(10) Pub. No.: US 2014/0124595 A1
(43) Pub. Date: May 8, 2014

(54) PROTECTIVE NOZZLE TOP ASSEMBLY FOR POP-UP SPRINKLER

(71) Applicant: CARL L.C. KAH, JR., North Palm Beach, FL (US)

(72) Inventor: CARL L.C. KAH, JR., North Palm Beach, FL (US)

(21) Appl. No.: 14/072,302

(22) Filed: Nov. 5, 2013

Related U.S. Application Data
(60) Provisional application No. 61/722,324, filed on Nov. 5, 2012.

(51) Int. Cl. B05B 15/00

(52) U.S. Cl. CPC B05B 15/001
USPC 239/204; 239/288.5

(57) ABSTRACT

A protective nozzle top assembly for a pup-up sprinkler assembly includes a center opening to protect an attached retractable nozzle assembly when the sprinkler is in its non-operating condition. In an embodiment, the protective nozzle top assembly includes a secondary top surface positioned over a conventional primary top surface with water and dirt drainage between the two in order to provide dirt protection as well as protection from contact with lawn equipment, personnel and auto tires.

### CROSS-REFERENCE TO RELATED APPLICATIONS

The present application claims benefit of and priority to U.S. Provisional Patent Application No. 61/722,324 filed Nov. 5, 2012 entitled NOZZLE GUARD TOP FOR POP-UP SPRINKLERS, the entire content of which is hereby incorporated by reference herein.

### BACKGROUND

1. Field of the Disclosure

The present disclosure relates to a protective nozzle top assembly for use with turf type sprinklers for in-ground installation and a sprinkler assembly with a top that includes a protective assembly.

2. Related Art

Water distribution nozzle assemblies of the type that are removable and changeable from an exposed top of in-ground installed sprinklers need to provide protection for the nozzle assembly from lawn maintenance equipment, such as line trimmers i.e. the WEED EATER® (a registered trademark of Husqvarna Consumer Outdoor Products) or the wheels of powered lawn mowers. Such nozzle assemblies also should include enhanced protection from intrusion of dirt and debris into the nozzle assembly. U.S. Pat. No. 7,600,699 shows a typical pop-up type irrigation sprinkler that utilizes a riser that pops up from an in-ground installed stationary sprinkler body. The exposed top of the nozzle assembly is the uppermost part of the exposed top of the in-ground exposed sprinkler.

Because of the ever increasing cost of water and the desire to save water, more complicated nozzle assemblies, such as that disclosed in co-pending U.S. patent application Ser. No. 11/947,571, filed Nov. 29, 2007, published as U.S. Patent Publication No. 2008-0257982, the entire content of which is hereby incorporated by reference herein, are being used in in-ground sprinklers. Because of the cost and complexity of such nozzle assemblies, there is an increased need to better protect them from damage and dirt from the surrounding soil.

### SUMMARY

A protective top for a pop-up type irrigation sprinkler that utilizes a riser that is moveable up and down in a stationary sprinkler body includes a second top surface supported above a primary water sealing top of the sprinkler.

The second top surface is supported on ribs or partial circumferential surfaces around the top of the primary water sealing top of the sprinkler. A center opening in this secondary top is provided to allow the pop-up nozzle assembly to be retracted below the top surface of the secondary top, which is exposed to protect the primary water sealing top from contact by lawn maintenance equipment.

An intermediate area, positioned between the two sprinkler tops, allows water discharged from the sprinkler nozzle during irrigation system water shut down, as the sprinkler's riser retraction spring pulls the riser back into the sprinkler body to force additional displaced water from the inside of the sprinkler body and the nozzle assembly, to drain between the two top covers.

A notch or slot in the circumference around the nozzle assembly center opening is provided so that an edge of the recessed, retracted nozzle assembly may be contacted to allow lifting of the nozzle assembly and sprinkler riser up and out of the secondary top recess hole for changing nozzle assemblies or maintenance, such as, removing the nozzle assembly to allow for cleaning of the nozzle assembly filter.

A protective nozzle top assembly for a pop-up type sprinkler in accordance with an embodiment of the present application includes a substantially circular body including a top surface and an opposing bottom surface, the circular body configured for mounting on a top of the pop-up sprinkler and a circular opening formed in a center of the substantially circular body and configured to allow the riser and a nozzle assembly mounted thereon to pass therethrough and the nozzle assembly to retract into the circular opening.

A pop-up sprinkler assembly in accordance with an embodiment of the present application includes a cylindrical sprinkler body including a top portion, a riser mounted in the cylindrical sprinkler body and movable between a retracted position wherein the riser is substantially within the cylindrical body and an extended position wherein the riser extends up above the cylindrical sprinkler body, a rotary nozzle assembly positioned on top of the riser; and a protective nozzle top assembly mounted on the top portion of the cylindrical sprinkler body, the protective nozzle top assembly including a substantially circular body including a top surface and an opposing bottom surface, a circular opening formed in a center of the substantially circular body and configured to allow the riser to pass therethrough and for the nozzle assembly to retract into the circular opening and at least one rib extending downward from the bottom surface of the circular body and contacting the top portion of the cylindrical sprinkler body such that a gap is formed between the protective nozzle top assembly and the top of the cylindrical sprinkler body.

A pop-up sprinkler assembly in accordance with an embodiment of the present disclosure includes a cylindrical sprinkler body including a top portion, a riser mounted in the cylindrical sprinkler body and movable between a retracted position wherein the riser is substantially within the cylindrical body and an extended position wherein the riser extends up above the cylindrical sprinkler body and a rotary nozzle assembly positioned on top of the riser, the top portion of the cylindrical sprinkler body including a first surface sealingly engaging the cylindrical sprinkler body to prevent water from escaping from the sprinkler body and including a riser opening formed in a center thereof configured to allow the riser to move from the retracted position to the extended position; and a second surface spaced a distance above the first surface and including a second riser opening formed in a center thereof configured to allow the riser to move from the retracted position to the extended position such that an intermediate area is formed between the first surface and the second surface in which the rotary nozzle assembly is positioned when the riser is in the retracted position.

Other features and advantages of the present disclosure will become apparent from the following description of the invention which refers to the accompanying drawings.

### BRIEF DESCRIPTION OF THE DRAWINGS

FIG. 1 shows a perspective view of a pop-up sprinkler with a sprinkler nozzle assembly installed on it with the riser retracted through the center opening of a protective nozzle top assembly in accordance with an embodiment of the present disclosure mounted on top of the sprinkler.

FIG. 1A shows a perspective view of the same sprinkler as in FIG. 1 with the riser and nozzle assembly extended up in an operating position.

FIG. 2 shows a perspective view of a conventional sprinkler without the protective nozzle top assembly.

FIG. 3 is a more detailed perspective view of a top of the pop-up sprinkler and the protective nozzle top assembly of FIGS. 1 and 1A.

FIG. 4 shows a more detailed perspective view of the protective nozzle top assembly.

FIG. 5 shows a detailed perspective view of a protective nozzle top assembly in accordance with another embodiment of the present disclosure.

### DETAILED DESCRIPTION OF PREFERRED EMBODIMENTS

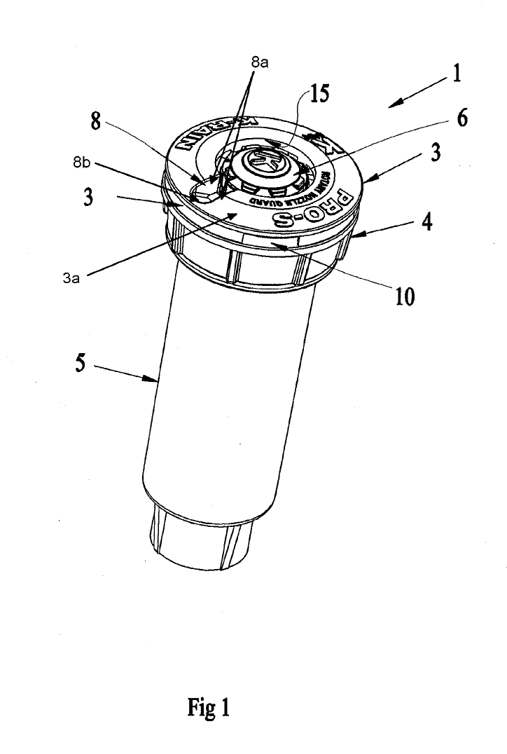

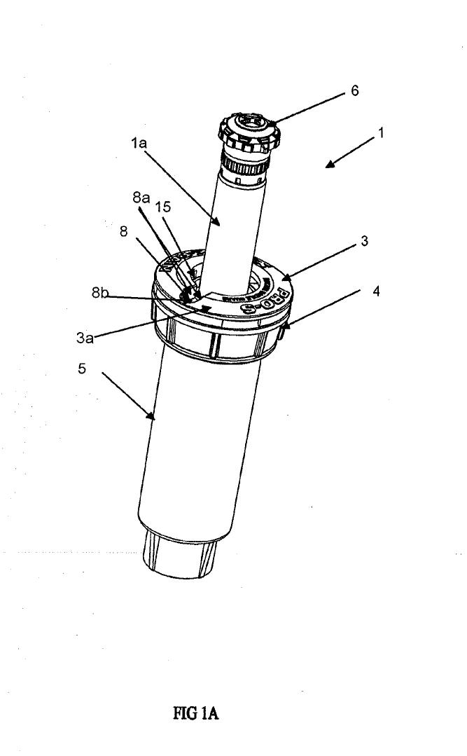

A protective nozzle top 3 in accordance with an embodiment of the present disclosure is illustrated attached to a top 4 of a sprinkler assembly 1 in FIG. 1. A center recess area or opening 15 in the protective nozzle top 3 on the sprinkler assembly 1 includes a water and dirt drain area or channel 10 extending from the center recess area or opening 15. FIG. 1A illustrates the riser 1a of the sprinkler assembly 1 extended through the center opening 15 in its operational position.

The center recess area or opening 15 provides both mechanical protection for the valuable rotary nozzle assembly 6, and also provides dirt protection from the surrounding soil since the sprinkler body 5 is typically installed at ground level or below ground level.

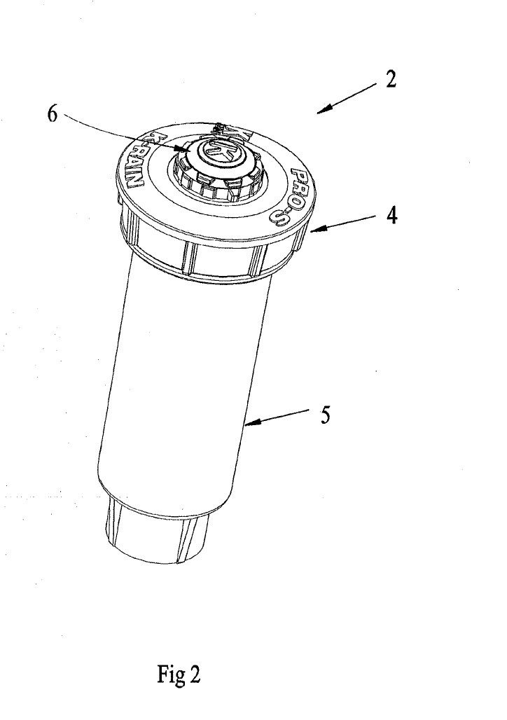

FIG. 2 shows a perspective view of a conventional sprinkler assembly 2 with a valuable rotary nozzle assembly 6 attached to its center retractable riser 1a. The riser 1a will pop the rotary nozzle assembly 6 up above ground level when the sprinkler is pressurized into the operating position as shown in FIG. 1A, for example. When water pressure is shut off, however, the nozzle assembly 6 would be exposed at the top center of a top 4 of a conventional sprinkler assembly 2 as illustrated in FIG. 2, for example. The protective nozzle top 3 of the present disclosure provides a center recess area or opening 15 in which the nozzle assembly 6 is protected when retracted as shown in FIG. 1, for example. In conventional sprinklers, the valuable rotary nozzle assembly 6 would be very vulnerable to damage from rotary line trimmers such as the WEED EATER®, for example.

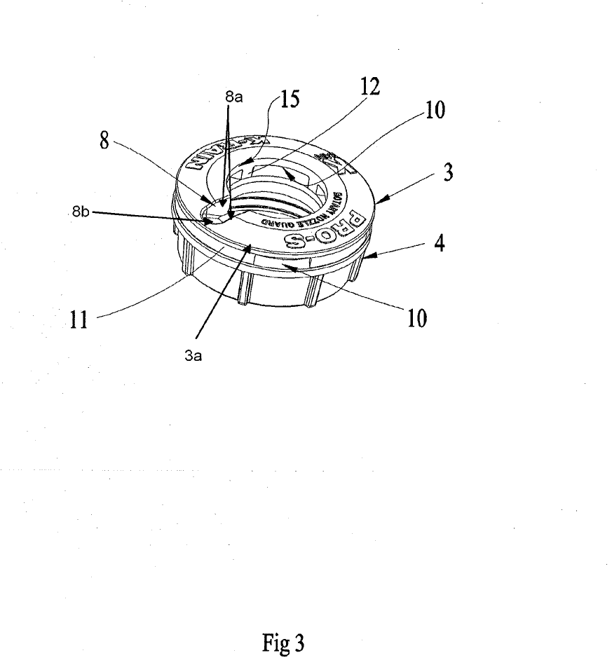

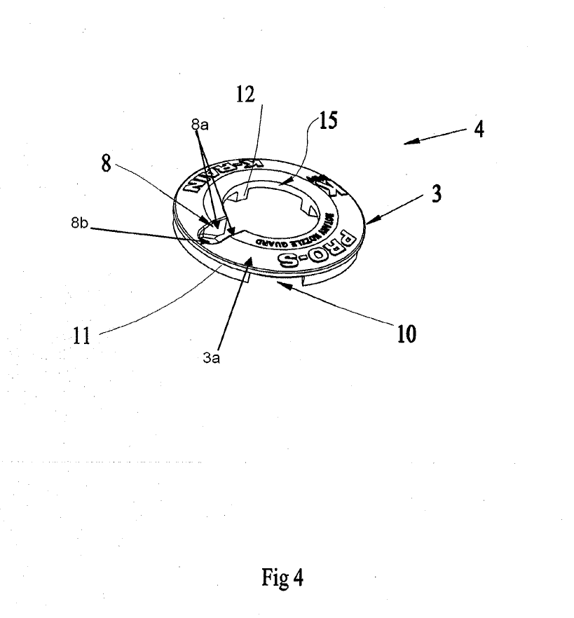

The protective nozzle top 3 of the present disclosure includes the center recess area or opening 15 and a nozzle lifting access slot 8 shown in FIGS. 1, 1A, 3 and 4, for example. The nozzle lifting access slot 8 allows the edge of the nozzle assembly 6 to be contacted even when retracted to aid in lifting the nozzle assembly and riser 1a out of the sprinkler 1 for cleaning, replacement, etc. As can be seen in FIG. 3, for example, the slot 8 is formed adjacent to the center recess area or opening 15 and extends outward therefrom a distance toward the outer edge of the nozzle top 3. In a preferred embodiment, a bottom wall 8b of the slot 8 is angled downward starting from an outer end of the slot and extending toward the recess area or opening 15. The slot 8 preferably does not extend all the way out to the periphery of the protective nozzle top assembly 3. The bottom wall 8b joins a bottom edge of two opposing sidewalls 8a that extend upward from the bottom wall 8b to meet the top surface 3a of the protective nozzle top assembly 3. In this manner, the slot 8 allows a user to access the nozzle assembly 6 when it is retracted, while still protecting the nozzle assembly.

The protective nozzle top 3 includes the secondary top surface 3a positioned over the conventional nozzle top 4 to provide dirt cleaning features as well as protection for the nozzle assembly 6 as shown in FIGS. 1 and FIG. 3. A bottom surface of the protective nozzle top is provided opposite the top surface 3a.

Including the secondary top cover surface 3a with connecting drain passages 10 from the center recess area 15 to the outside area around the sprinkler 1 allows water and dirt from the surrounding ground that may have gotten into recess 15 to be flushed out through at least one, and preferably multiple passages or channels 10 to the outside and away from the sprinkler nozzle assembly 6 as the sprinkler riser 1a retracts under the force from its retraction spring when the system water supply is shut off. The additional water volume is from the sprinkler housing or body 5 that is displaced by the nozzle assembly 6 as the pop-up riser 1a is retracted back into sprinkler body 5 and the nozzle assembly 6 is retracted into the opening 15.

The protective nozzle top 3 is preferably sonic welded onto the top 4 of the sprinkler 1, however, any suitable connection may be used. Specifically, one or more ribs 12 preferably extend downward from the bottom surface of the top 3 and are sonic welded to the conventional top 4. The ribs 12 are positioned such that one or more channels 10 are configured to extend from the central recess 15 all the way to the outer perimeter of the top 3. That is, there is space between the bottom surface of the protective top 3 and the top 4 of the sprinkler assembly 1. This space provides an intermediate area in which the nozzle assembly 6 is protected when the riser 1a is retracted. A protective flange 11 may be provided around an outer edge of the top 3. The flange 11 preferably extends downward from the outer edge of the top 3. The flange 11 may be sonic welded to the top 3, if desired, or molded therewith. The flange serves to prevent dirt from intruding under the top 3 and into the nozzle assembly 6. The flange 11 includes one or more openings 11a, at least one of which is aligned with the channels 10 to drain water and dirt from the recess 15.

The protective nozzle top 3 of the present disclosure may be added onto an existing sprinkler assembly or may be provided during manufacture of the sprinkler assembly. While the protective nozzle top 3 of the present application preferably includes the slot 8, the slot 8 may be removed if desired.

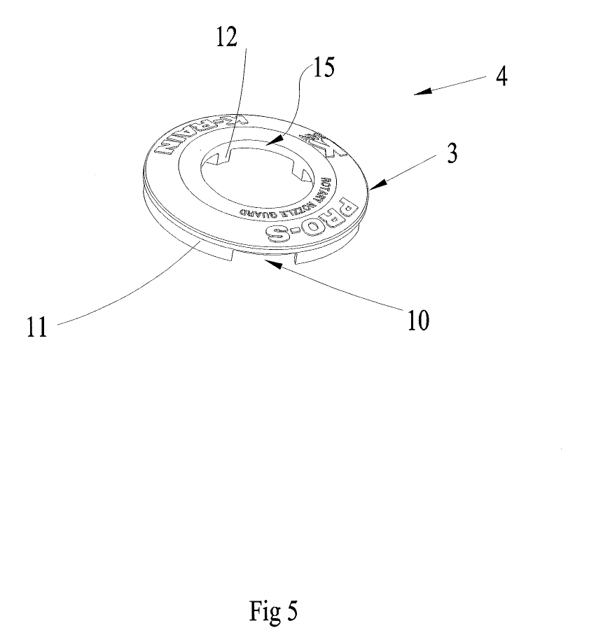

While it is preferred that the protective nozzle top 3 include the slot 8, the slot is not a necessary element of the top 3. FIG. 5 illustrates a close up view of a protective nozzle top 3 that does not include the slot 8.

Although the present invention has been described in relation to particular embodiments thereof, many other variations and modifications and other uses will become apparent to those skilled in the art.

What is claimed is:

1. A protective nozzle top assembly for a pop-up sprinkler with a riser comprises:
a substantially circular body including a top surface and an opposing bottom surface, the circular body configured for mounting on a top of the pop-up sprinkler; and
a circular opening formed in a center of the substantially circular body and configured to allow the riser and a nozzle assembly mounted thereon to pass therethrough and the nozzle assembly to retract into the circular opening.

2. A protective nozzle top assembly of claim 1, further comprising at least one rib extending downward from the bottom surface of the circular body and configured to contact a top of the pop-up sprinkler such that a gap is formed between the protective nozzle top assembly and the top of the pop-up sprinkler.

3. The nozzle top assembly of claim 2, further comprising a slot formed in the substantially circular body adjacent to the central opening and configured and operable to allow access to the central opening.

4. The protective nozzle assembly of claim 2, further comprising a flange extending downward from an outer edge of the substantially circular body and including at least one opening formed therein.

5. The protective nozzle assembly of claim 4, further comprising at least one additional rib extending downward from the bottom surface of the circular body and configured to contact the top of the pop-up sprinkler, the at least one additional rib spaced from the at least one rib such that drainage channels are formed between the at least one rib and the at least one additional rib.

6. The protective nozzle assembly of claim 5, wherein the at least one opening in the flange is aligned with at least one of the drainage channels.

7. The protective nozzle assembly of claim 4, further comprising a plurality of ribs extending downward from the bottom surface of the circular body and configured to contact the top of the pop-up sprinkler, the plurality of ribs spaced apart from the at least one rib and each other such that a plurality of drainage channels are formed.

8. The protective nozzle assembly of claim 7, wherein the at least one opening in the flange is aligned with at least one of the plurality of drainage channels.

9. The protective nozzle assembly of claim 7, wherein the flange includes a plurality of openings formed therein, wherein each opening of the plurality of openings is aligned with one of the plurality of drainage channels.

10. A pop-up sprinkler assembly comprising:
a cylindrical sprinkler body including a top portion;
a riser mounted in the cylindrical sprinkler body and movable between a retracted position wherein the riser is substantially within the cylindrical body and an extended position wherein the riser extends up above the cylindrical sprinkler body;
a rotary nozzle assembly positioned on top of the riser; and
a protective nozzle top assembly mounted on the top portion of the cylindrical sprinkler body;
the protective nozzle top assembly including:
a substantially circular body including a top surface and an opposing bottom surface;
a circular opening formed in a center of the substantially circular body and configured to allow the riser to pass therethrough and for the nozzle assembly to retract into the circular opening;
at least one rib extending downward from the bottom surface of the circular body and contacting the top portion of the cylindrical sprinkler body such that a gap is formed between the protective nozzle top assembly and the top of the cylindrical sprinkler body.

11. The sprinkler assembly of claim 10, wherein the protective nozzle top further comprises a slot formed in the substantially circular body adjacent to the central opening and configured and operable to allow access to the central opening.

12. The sprinkler assembly of claim 10 wherein the protective nozzle top assembly further comprises a flange extending downward from an outer edge of the substantially circular body and including at least one opening formed therein.

13. The sprinkler assembly of claim 12 wherein the protective nozzle top assembly further comprises at least one additional rib extending downward from the bottom surface of the substantially circular body and contacting the top portion of the cylindrical sprinkler body, the at least one additional rib spaced from the at least one rib such that drainage channels are formed between the at least one rib and the at least one additional rib.

14. The sprinkler assembly of claim 13, wherein the at least one opening in the flange is aligned with at least one of the drainage channels.

15. The sprinkler assembly of claim 12, wherein the protective nozzle top assembly further comprises a plurality of ribs extending downward from the bottom surface of the circular body and contacting the top portion of the cylindrical sprinkler body, the plurality of ribs spaced apart from the at least one rib and each other such that a plurality of drainage channels are formed.

16. The sprinkler assembly of claim 15, wherein the at least one opening in the flange is aligned with at least one of the plurality of drainage channels.

17. The sprinkler assembly of claim 16, wherein the flange includes a plurality of openings formed therein, wherein each opening of the plurality of openings is aligned with one of the plurality of drainage channels.

18. A pop-up sprinkler assembly comprising:
a cylindrical sprinkler body including a top portion;
a riser mounted in the cylindrical sprinkler body and movable between a retracted position wherein the riser is substantially within the cylindrical body and an extended position wherein the riser extends up above the cylindrical sprinkler body;
a rotary nozzle assembly positioned on top of the riser;
the top portion of the cylindrical sprinkler body including:
a first surface sealingly engaging the cylindrical sprinkler body to prevent water from escaping from the sprinkler body and including a riser opening formed in a center thereof configured to allow the riser to move from the retracted position to the extended position; and
a second surface spaced a distance above the first surface and including a second riser opening formed in a center thereof configured to allow the riser to move from the retracted position to the extended position such that an intermediate area is formed between the first surface and the second surface in which the rotary nozzle assembly is positioned when the riser is in the retracted position.

19. The sprinkler assembly of claim 17, wherein the second surface further comprises a slot formed adjacent to the second riser opening and configured and operable to allow access to the intermediate area.
